(19) United States
(12) Patent Application Publication
(10) Pub. No.: US 2015/0261990 A1
(43) Pub. Date: Sep. 17, 2015

(54) METHOD AND APPARATUS FOR COMPRESSING DNA DATA BASED ON BINARY IMAGE

(71) Applicant: Electronics and Telecommunications Research Institute, Daejeon (KR)

(72) Inventors: Dae Hee KIM, Daejeon (KR); Ho Youl JUNG, Daejeon (KR); Min Ho KIM, Daejeon (KR); Myung Eun LIM, Daejeon (KR); Jae Hun CHOI, Daejeon (KR)

(21) Appl. No.: 14/480,216

(22) Filed: Sep. 8, 2014

(30) Foreign Application Priority Data
Feb. 5, 2014 (KR) 10-2014-0013134

(51) Int. Cl. G06K 9/00; G06T 9/00

(52) U.S. Cl. CPC G06K 9/00; G06T 9/00; G06T 2207/30072; G06K 2209/07

(57) ABSTRACT

Provided are a method and apparatus for compressing DNA data based on a binary image. The method for compressing DNA data based on a binary image includes splitting DNA data including adenine (A), thymine (T), guanine (G), cytosine (C), and an indefinite base (N) into a plurality of binary images, determining a coding mode of each of the binary images according to characteristics of each of the binary images, and first coding each of the binary images based on the determined coding mode.

### CROSS-REFERENCE TO RELATED APPLICATIONS

This application claims priority under 35 U.S.C. §119 to Korean Patent Application No. 10-2014-0013134, filed on Feb. 5, 2014, the disclosure of which is incorporated herein by reference in its entirety.

### TECHNICAL FIELD

The present invention relates to a method and apparatus for compressing DNA data, and more particularly, to a method and apparatus for compressing DNA data based on a binary image.

### BACKGROUND

Human genome composed of adenine (A), thymine (T), guanine (G), cytosine (C), and an indefinite base (N) includes approximately three billion bases, and storing the data as a character string requires three billion bytes, which is equivalent to capacity of about 2.9 GB. A method of storing each base by 2 bits (00, 01, 10, 11) or 3 bits, but this method also requires a storage space of approximately 750 MB to 1 GB.

When human genome project is activated in the future, large capacity DNA data may be generated, and DNA data compression, as well as a space for storing the DNA data, is an important issue. Data compression algorithms in image processing fields have made significant progress to algorithms such as bz2, nrdb+bz2, PPMdi, 7z, and the like, but these algorithms do not serve only for DNA data and a compression algorithm specified for DNA data is required.

### SUMMARY

Accordingly, the present invention provides a method and apparatus for compression DNA data capable of converting DNA data into a plurality of binary images and compressing a binary image file generated according to the conversion result through parallel processing, thus enhancing compression efficiency and performance.

The object of the present invention is not limited to the aforesaid, but other objects not described herein will be clearly understood by those skilled in the art from descriptions below.

In one general aspect, a method for compressing DNA data based on a binary image includes: splitting DNA data including adenine (A), thymine (T), guanine (G), cytosine (C), and an indefinite base (N) into a plurality of binary images; determining a coding mode of each of the binary images according to characteristics of each of the binary images; and first coding each of the binary images based on the determined coding mode.

The splitting of DNA data into a plurality of binary images may include coding any one type of base of the DNA data to 1 and the other remaining bases to 0.

The splitting of DNA data into a plurality of binary images may include generating a first binary image by coding adenine (A) to 1, a second binary image by coding thymine (T) to 1, a third binary image by coding cytosine (C) to 1, a fourth binary image by coding guanine (G) to 1, and a fifth binary image by coding an indefinite base (N) to 1 in the DNA data.

The determining of a coding mode may include determining a coding bit unit according to repeated numbers of 0 and 1 in the binary images.

The determining of a coding mode may include determining a coding unit of the first to fourth binary images, as a 3-bit unit, and a coding unit of the fifth binary image, as a 16-bit unit.

The first coding may include run-length-coding each of the binary images based on the determined coding mode.

The first coding may include run-length-coding the first to fourth binary images by 3-bit unit and the fifth binary image by 16-bit unit.

The method may further include performing Huffman coding using results of the first coding.

The performing of Huffman coding may include: reading results of the run-length coding of each of the binary images by N-bit unit to calculate a probability distribution of 2^{N} codes; generating a binary tree based on the probability distribution and assigning a prefix code having a shorter length to a code of higher frequency of occurrence; and generating a Huffman codebook with higher n codes (n is a maximum number that can be coded with N bits).

The performing of Huffman coding may include performing Huffman coding on each of the binary images in parallel by a multi-core.

In another general aspect, an apparatus for compressing DNA data based on a binary image includes: a binary image generating unit configured to split DNA data including adenine (A), thymine (T), guanine (G), cytosine (C), and an indefinite base (N) into a plurality of binary images; first and second coding units configured to run-length-code each of the binary images based on a coding mode determined according to characteristics of each of the binary images; and first and second Huffman coding units configured to perform Huffman coding using coding results from the first and second coding units.

The binary image generating unit may code any one type of base of the DNA data to 1 and the other remaining bases to 0.

The binary image generating unit may generate a first binary image by coding adenine (A) to 1, a second binary image by coding thymine (T) to 1, a third binary image by coding cytosine (C) to 1, a fourth binary image by coding guanine (G) to 1, and a fifth binary image by coding an indefinite base (N) to 1 in the DNA data.

The first and second coding units may determine a coding bit unit according to repeated numbers of 0 and 1 in the binary images.

The first and second coding units may run-length-code the first to fourth binary images by a 3-bit unit and the fifth binary image by a 16-bit unit.

The first and second Huffman coding units may read results of the run-length coding determined for each of the binary images by N-bit unit to calculate a probability distribution of 2^{N} codes, generate a binary tree based on the probability distribution, assign a prefix code having a shorter length to a code of higher frequency of occurrence, and generate a Huffman codebook with higher n codes (n is a maximum number that can be coded with N bits).

### BRIEF DESCRIPTION OF THE DRAWINGS

FIG. 1 is a block diagram illustrating an apparatus for compressing DNA data based on a binary image according to an embodiment of the present invention;

FIG. 2 is a block diagram illustrating a method for compressing DNA data based on a binary image according to another embodiment of the present invention;

FIG. 3 is a flow chart illustrating an example of a method of generating a Huffman codebook according to an embodiment of the present invention;

FIG. 4 is a view illustrating a configuration of a computer device capable of executing a method for compressing DNA data based on a binary image according to an embodiment of the present invention; and

FIG. 5 is a view illustrating an example of DNA data.

### DETAILED DESCRIPTION OF EMBODIMENTS

The advantages, features and aspects of the present invention will become apparent from the following description of the embodiments with reference to the accompanying drawings, which is set forth hereinafter. The present invention may, however, be embodied in different forms and should not be construed as limited to the embodiments set forth herein. Rather, these embodiments are provided so that this disclosure will be thorough and complete, and will fully convey the scope of the present invention to those skilled in the art. The terms used herein are for the purpose of describing particular embodiments only and are not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

Hereinafter, exemplary embodiments of the present invention will be described in detail with reference to the accompanying drawings. In adding reference numerals for elements in each figure, it should be noted that like reference numerals already used to denote like elements in other figures are used for elements wherever possible. Moreover, detailed descriptions related to well-known functions or configurations will be ruled out in order not to unnecessarily obscure subject matters of the present invention.

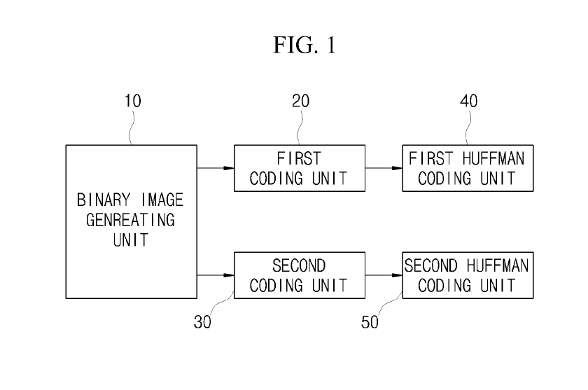

FIG. 1 is a block diagram illustrating an apparatus for compressing DNA data based on a binary image according to an embodiment of the present invention. Referring to FIG. 1, the apparatus for compressing DNA data based on a binary image according to an embodiment of the present invention includes a binary image generating unit 10, a first coding unit 20, a second coding unit 30, a first Huffman coding unit 40, and a second Huffman coding unit 50.

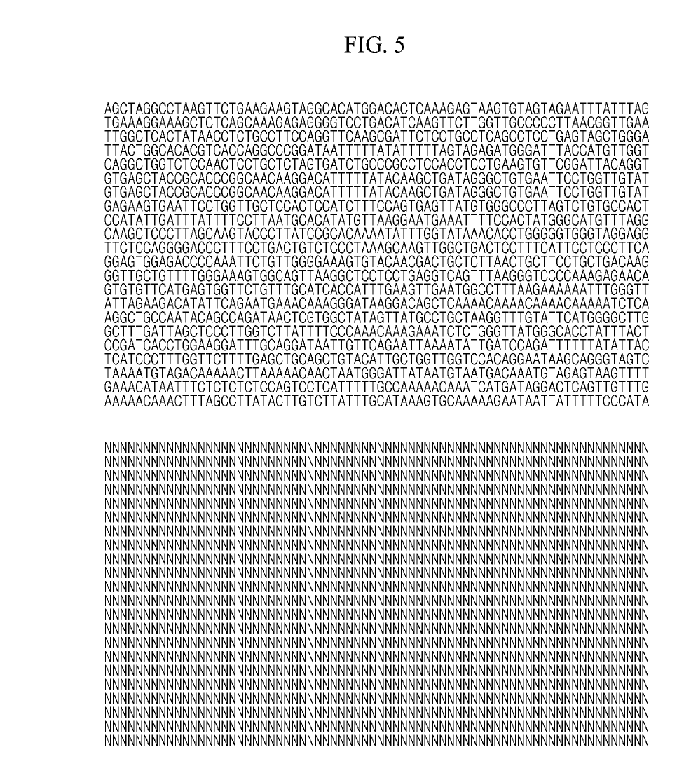

The binary image generating unit 10 may split DNA data including adenine (A), thymine (T), guanine (G), cytosine (C), and an indefinite base (N) into a plurality of binary images. As illustrated in FIG. 5 illustrating an example of DNA data, DNA data is composed of bases such as adenine (A), thymine (T), guanine (G), and cytosine (C), and has three billion base sequences. In FIG. 5, Ns is a region representing bases that have not been definitely ascertained, in which hundreds to thousands of data are concentrated all together, while the bases such as A, T, G, and C are randomly mixed.

In an embodiment in which DNA data having the aforementioned configuration is converted and/or split into a plurality of binary data composed of 0 and 1, the binary image generating unit 10 may utilize a method of coding a type of base of the DNA data to 1 and the other remaining bases to 0. For example, in case of DNA data such as “ATGCAATCCGATTAGGGAC,” when only the adenine (A) base is coded to 1 and the other remaining bases are coded to 0, binary data such as “1000110000100100010” is generated. Also, when only the thymine (T) base is coded to 1 and the other remaining bases are coded to 0, binary data such as “1000110000100100010” may be generated. When such a coding scheme is applied to cytosine (C), guanine (G), and an indefinite base (N), binary data such as “0010000001000011100,” “0001000110000000001,” and “0000000000000000000” are generated, respectively.

When 0 is defined as white and 1 is defined as black in each binary data, five general binary images configured in black and white are generated. The binary data generated according to such a scheme has the portion representing 0 that occupies 70% to 80% in terms of the characteristics of DNA data.

The first and second coding units 20 and 30 determine a coding mode with respect to each binary image according to characteristics of the binary images, and code each binary image based on the determined coding mode. In FIG. 1, two coding units, i.e., the first and second coding units, are illustrated, but more than two coding units may be applied to the present invention depending on types and number of determined coding modes. In the present embodiment, two coding modes are determined for the purposes of description. Each coding unit may perform coding on each binary image in parallel by a multi-core.

For example, the first and second coding units 20 and 30 may determine a coding bit unit according to the repeated number of 0 and 1 in the binary image. In the above description, when the binary images in which adenine (A), thymine (T), guanine (G), cytosine (C), and an indefinite base (N) are coded to 1, respectively, and the other bases are coded to 0 are determined as first to fifth binary images, respectively, the first coding unit 20 may perform coding on the first to fourth binary images in parallel and the second coding unit 30 may perform coding on the fifth binary image.

The fifth image in which the indefinite base N is coded to 1 and the other remaining bases are coded to 0 has a structure such as 1111 100000 . . . 0000000111 . . . 1110000 . . . 00000 in terms of characteristics, and thus, the fifth image may be configured as being optimized for run length coding. Thus, the binary data (or the binary images) are run-length-coded in a manner of 0 (number), 1 (number), 0 (number), . . . by applying a 16-bit coding unit.

For example, when data of the fifth binary image is 00 . . . 00(1500)111 . . . 11(50,000)000 . . . , 00(300) . . . , the data is coded to 0000010111011100,1100001101010000,0000000100101100 by 16 bits.

In the case of the first to fourth binary images in which adenine (A), thymine (T), cytosine (C), guanine (G) are coded to 1 and the other remaining bases are coded to 0, the first coding unit 20 run-length-code the binary images by applying a 3-bit coding unit.

For example, when data of the first binary image is configured as “00000010001000001110000,”, the first coding unit 20 splits the first binary image data into ‘000000’, ‘1’, ‘000’, ‘1’, ‘00000’, ‘111’, ‘0000’ and codes the same to “110,001,011,001, 101,011,100” by 3-bit coding unit.

The first and second Huffman coding units 40 and 50 perform Huffman coding using the coding results from the first coding unit 20 and the second coding unit 30. In FIG. 1, only two coding units, i.e., the first and second Huffman coding units, are illustrated, but more than two coding units may be applied to the present invention according to types and number of determined coding modes.

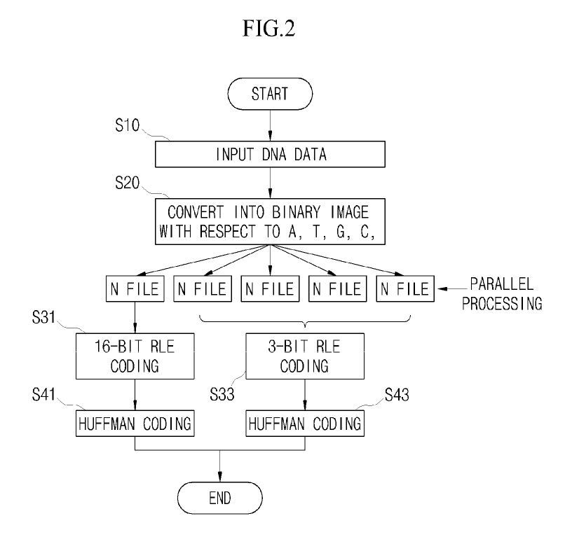

FIG. 2 is a block diagram illustrating a method for compressing DNA data based on a binary image according to another embodiment of the present invention.

When DNA data is input in step S10, the binary image generating unit 10 splits the DNA data including adenine (A), thymine (T), cytosine (C), guanine (G), and an indefinite base (N) into a plurality of binary images in step S20.

For example, using a method of coding any one type of base to 1 and the other remaining bases to 0 in the DNA data, the binary image generating unit 10 may convert the DNA data into binary data composed of 0 and 1. In this case, binary data (A file) in which only adenine (A) base of the DNA data is coded to 1 and the other remaining bases are coded to 0, binary data (T file) in which only thymine (T) base is coded to 1 and the other remaining bases are coded to 0, binary data (C file) in which only cytosine (C) base is coded to 1 and the other remaining bases are coded to 0, binary data (G file) in which only guanine (G) base is coded to 1 and the other remaining bases are coded to 0, and binary data (N file) in which only indefinite base (N) is coded to 1 and the other remaining bases are coded to 0 may be generated.

Thereafter, each binary data generated in step S20 is coded in parallel. For example, the first coding unit 20 and the second coding unit 30 determines a coding bit unit according to repeated numbers of 0 and 1 in the binary data, splits binary data according to the determined bit unit, and codes the binary data.

In detail, the first coding unit 20 may perform coding the binary data generated as the A, T, G, and C files in parallel by 3-bit coding unit in step S33, and the second coding unit 30 may perform coding the binary data generated as the N file by 16-bit coding unit in step S31).

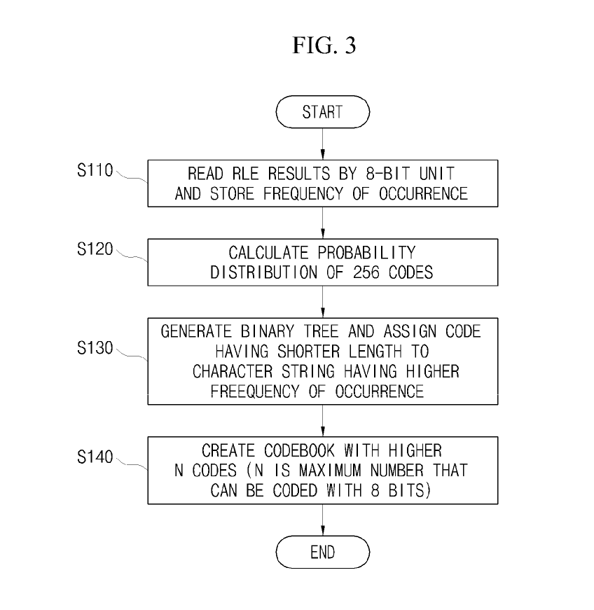

Thereafter, the first and second Huffman coding units 40 and 50 may perform Huffman coding using the coding results from the first coding unit 20 and the second coding unit 30 in steps S41 and S43. Hereinafter, a process of performing Huffman coding according to an embodiment of the present invention will be described in detail with reference to FIG. 3. FIG. 3 is a flow chart illustrating an example of a method of generating a Huffman codebook according to an embodiment of the present invention.

Huffman coding uses a principle that a prefix code with smaller capacity is assigned to high frequency code to save a storage space as much. For example, when a character string includes twenty ‘a’ codes and five ‘b’ codes, if 100 is assigned to code ‘a’ and 11 is assigned to code ‘b’, a magnitude of converted data is 3 (bit number of 100)×20+2 (bit number of 11)×5 =70 bits, and conversely, if 11 is assigned to code ‘a’ and 100 is assigned to code ‘b’, a magnitude of converted data may be 2 (bit number of 11)×20+3 (bit number of 100)×5 =55. Thus, assigning a lower prefix code to the code ‘a’ with relatively high frequency is advantageous in terms of compression efficiency.

Huffman coding uses a binary tree structure in expressing a prefix code. In an embodiment of the present invention, Huffman coding uses a book created based on frequency of each code by reading codes (composed of 0 and 1) generated according to the run-length coding as in steps S31 and S33 by a predetermined unit.

In a specific embodiment, the first and second Huffman coding units 40 and 50 read run-length coding results with respect to each binary image by N-bit unit and calculate a probability distribution with respect to 2^{N} codes (S110 and S120). For example, in case of run-length coding by 16-bit unit, the first and second Huffman coding units 40 and 50 may read run-length-coding results by 8-bit unit to obtain a probability distribution with respect to a total of 256 (2⁸) codes.

Next, the first and second Huffman coding units 40 and 50 generate a binary tree based on the probability distribution and assign a prefix code having a shorter length to a code of higher frequency of occurrence in step S130.

The first and second Huffman coding units 40 and 50 create a Huffman codebook with higher n codes (n is a maximum number that may be coded with N bits) and utilize the Huffman codebook for Huffman coding in step S140.

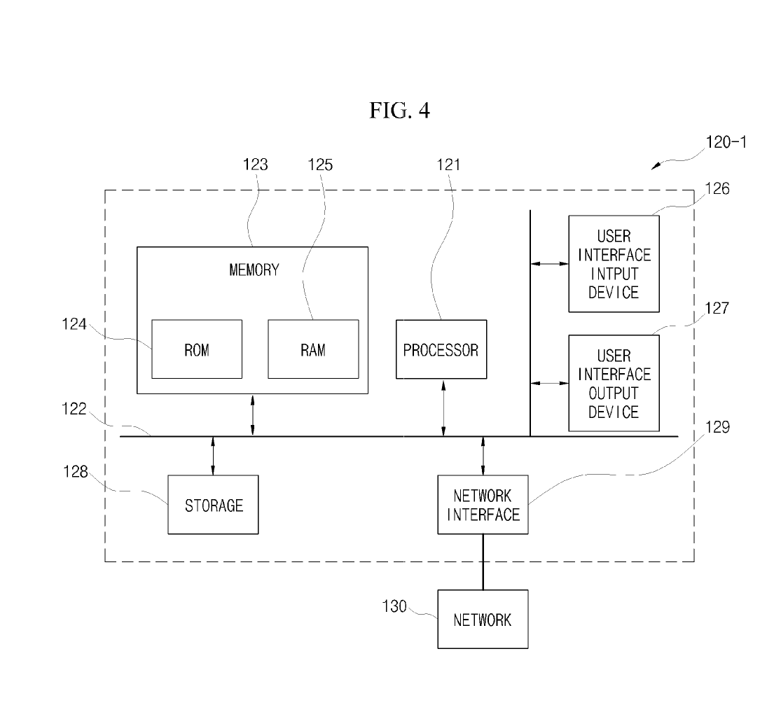

The method for compressing DNA data based on a binary image according to an embodiment of the present invention may be implemented in a computer system or recorded in a recording medium. As illustrated in FIG. 4, the computer system may include one or more processors 121, a memory 123, a user interface input device 126, a data communication bus 122, a user interface output device 127, and a storage 128. Each of the foregoing elements performs data communication through the data communication bus 122.

The computer may further include a network interface 129 coupled to a network. The processor 121 may be a central processing unit (CPU) or a semiconductor device that processes a command stored in the memory 123 and/or the storage 128.

The memory 123 and the storage 128 may include various volatile or nonvolatile storage mediums. For example, the memory 123 may include a read-only memory (ROM) 124 and a random access memory (RAM) 125.

According to an embodiment of the present invention, DNA data is split into a plurality of binary images and the split binary image files are compressed through parallel processing, enhancing compression efficiency and performance. In particular, the binary image files are compressed again by adaptively performing run-length-coding according to characteristics of the binary images, a Huffman codebook is generated using the compression results, and coding is performed again, thus guaranteeing a high compression rate. Also, since the split binary image files are parallel-processed using a multi-core, a high compression rate may be obtained.

Thus, the method for compressing DNA data based on a binary image according to an embodiment of the present invention may be implemented as a computer-executable method. When the method for compressing DNA data based on a binary image according to an embodiment of the present invention is performed in a computer apparatus, computer-readable commands may perform a recognition method according to the present invention.

The method for compressing DNA data based on a binary image according to the present invention may also be embodied as computer-readable codes on a computer-readable recording medium. The computer-readable recording medium is any data storage device that may store data which may be thereafter read by a computer system. Examples of the computer-readable recording medium include read-only memory (ROM), random access memory (RAM), CD-ROMs, magnetic tapes, floppy disks, and optical data storage devices. The computer-readable recording medium may also be distributed over network coupled computer systems so that the computer-readable code may be stored and executed in a distributed fashion.

The above-described subject matter is to be considered illustrative and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method for compressing DNA data based on a binary image, the method comprising:
splitting DNA data including adenine (A), thymine (T), guanine (G), cytosine (C), and an indefinite base (N) into a plurality of binary images;
determining a coding mode of each of the binary images according to characteristics of each of the binary images; and
first coding each of the binary images based on the determined coding mode.

2. The method of claim 1, wherein the splitting of DNA data into a plurality of binary images comprises coding any one type of base of the DNA data to 1 and the other remaining bases to 0.

3. The method of claim 1, wherein the splitting of DNA data into a plurality of binary images comprises generating a first binary image by coding adenine (A) to 1, a second binary image by coding thymine (T) to 1, a third binary image by coding cytosine (C) to 1, a fourth binary image by coding guanine (G) to 1, and a fifth binary image by coding an indefinite base (N) to 1 in the DNA data.

4. The method of claim 1, wherein the determining of a coding mode comprises determining a coding bit unit according to repeated numbers of 0 and 1 in the binary images.

5. The method of claim 3, wherein the determining of a coding mode comprises determining a coding unit of the first to fourth binary images, as a 3-bit unit, and a coding unit of the fifth binary image, as a 16-bit unit.

6. The method of claim 1, wherein the first coding comprises run-length-coding each of the binary images based on the determined coding mode.

7. The method of claim 3, wherein the first coding comprises run-length-coding the first to fourth binary images by 3-bit unit and the fifth binary image by 16-bit unit.

8. The method of claim 1, further comprising performing Huffman coding using results of the first coding.

9. The method of claim 8, wherein the performing of Huffman coding comprises:
reading results of the run-length coding of each of the binary images by N-bit unit to calculate a probability distribution of 2^{N} codes;
generating a binary tree based on the probability distribution and assigning a prefix code having a shorter length to a code of higher frequency of occurrence; and
generating a Huffman codebook with higher n codes (n is a maximum number that can be coded with N bits).

10. The method of claim 8, wherein the performing of Huffman coding comprises performing Huffman coding on each of the binary images in parallel by a multi-core.

11. An apparatus for compressing DNA data based on a binary image, the apparatus comprising:
a binary image generating unit configured to split DNA data including adenine (A), thymine (T), guanine (G), cytosine (C), and an indefinite base (N) into a plurality of binary images;
first and second coding units configured to run-length-code each of the binary images based on a coding mode determined according to characteristics of each of the binary images; and
first and second Huffman coding units configured to perform Huffman coding using coding results from the first and second coding units.

12. The apparatus of claim 11, wherein the binary image generating unit codes any one type of base of the DNA data to 1 and the other remaining bases to 0.

13. The apparatus of claim 11, wherein the binary image generating unit generates a first binary image by coding adenine (A) to 1, a second binary image by coding thymine (T) to 1, a third binary image by coding cytosine (C) to 1, a fourth binary image by coding guanine (G) to 1, and a fifth binary image by coding an indefinite base (N) to 1 in the DNA data.

14. The apparatus of claim 11, wherein the first and second coding units determine a coding bit unit according to repeated numbers of 0 and 1 in the binary images.

15. The apparatus of claim 13, wherein the first and second coding units run-length-code the first to fourth binary images by a 3-bit unit and the fifth binary image by a 16-bit unit.

16. The apparatus of claim 11, wherein the first and second Huffman coding units read results of the run-length coding determined for each of the binary images by N-bit unit to calculate a probability distribution of 2^{N} codes, generate a binary tree based on the probability distribution, assign a prefix code having a shorter length to a code of higher frequency of occurrence, and generate a Huffman codebook with higher n codes (n is a maximum number that can be coded with N bits).
